(19) United States
(12) Patent Application Publication
(10) Pub. No.: US 2023/0362877 A1
(43) Pub. Date: Nov. 9, 2023

(54) POSITIONING SYSTEM, WIRELESS BASE STATION APPARATUS, AND POSITIONING METHOD

(71) Applicant: NIPPON TELEGRAPH AND TELEPHONE CORPORATION, Tokyo (JP)

(72) Inventors: Masashi IWABUCHI, Musashino-shi, Tokyo (JP); Tomoaki OGAWA, Musashino-shi, Tokyo (JP); Tomoki MURAKAMI, Musashino-shi, Tokyo (JP)

(73) Assignee: NIPPON TELEGRAPH AND TELEPHONE CORPORATION, Tokyo (JP)

(21) Appl. No.: 17/911,522

(22) PCT Filed: Mar. 18, 2020
(86) PCT No.: PCT/JP2020/011945

§ 371 Date: Sep. 14, 2022

(51) Int. Cl. H04W 64/00; G01S 5/02

(52) U.S. Cl. CPC H04W 64/006; G01S 5/0273

(57) ABSTRACT

A positioning system according to an aspect of the present invention includes a wireless base station device that communicates with a wireless terminal; one or more relay devices that relay a signal between the wireless terminal and the wireless base station device; and a positioning device that estimates a position of the wireless terminal on the basis of a first signal received by the wireless base station device from the wireless terminal via a first relay device, which is one of the one or more relay devices, a position of the one or more relay devices, and a position of the wireless base station device.

### TECHNICAL FIELD

The present invention relates to technology for estimating the position of a wireless terminal.

### BACKGROUND ART

The advancement of Internet of Things (IoT) and big data technology has led to an increase in the importance of position information. Determining position via the Global Positioning System (GPS) outside and determining position via Wi-Fi or a sensor inside is being looked into, and adding a positioning function to a wireless communication system using 3GPP (registered trademark), IEEE 802.11, or a similar standardized protocol is being considered.

Up until now, use cases in which wireless terminals are used for positioning have been predominant. However, with the advancements in big data technology, in order to provide better services to users, there is a growing expectation for the positions of wireless terminals to be determined on the network side and the obtained position information to be used in various services. By the positions of terminals being able to be determined on the network side (hereinafter, referred to as network positioning), the dependency on the performance of the terminals can be eliminated, allowing for highly accurate positioning to be performed, and other advantages.

With expectations that the position information will be used by various services, the accuracy of the data is also an issue. In wireless positioning, positioning is performed using received power, radio wave time of arrival, and radio wave direction of arrival. In a case where low frequency radio waves are used, positioning using radio wave time of arrival is effective, but the area with equal power is large and it is difficult to estimate the direction of arrival with high accuracy. Thus, positioning with a high accuracy is difficult. Regarding this, positioning using high frequency radio waves has been gathering attention. Using narrow beamforming, the direction of arrival can be estimated with relatively high accuracy, and because the radio waves attenuate greatly, the area with equal power is relatively small. Also, because using a high frequency band also allows positioning to be performed using radio wave time of arrival as when using a low frequency band, the accuracy of positioning can be increased.

### CITATION LIST

### Patent Literature

[PTL 1] JP 2017-191098

### SUMMARY OF THE INVENTION

### Technical Problem

However, high frequency radio waves are easily shielded, and highly accurate positioning is difficult in areas without an unobstructed view of the base station. Also, in the case of network positioning, multiple base stations are required. Reducing the areas without an unobstructed view and installing base stations so that a terminal can connect to multiple base stations as required leads to the network installation costs being increased. In addition, in the case of positioning using radio waves time of arrival, the base stations need to be synchronized. Also, the multiple base stations need to receive the radio waves from the same terminal. This means that the terminal needs to change its serving base station to transmit a signal.

In light of the foregoing, the present invention is directed at providing technology enabling highly accurate positioning that is not dependent on the performance of a terminal and that can be performed even when the terminal is located in an area without an unobstructed view of a base station.

### Means for Solving the Problem

A positioning system according to an aspect of the present invention includes a wireless base station device that communicates with a wireless terminal; one or more relay devices that relay a signal between the wireless terminal and the wireless base station device; and a positioning device that estimates a position of the wireless terminal on the basis of a first signal received by the wireless base station device from the wireless terminal via a first relay device, which is one of the one or more relay devices, a position of the one or more relay devices, and a position of the wireless base station device.

### Effects of the Invention

According to the present invention, highly accurate positioning can be achieved that is not dependent on the performance of a terminal and can be performed when a terminal is located in an area without an unobstructed view of a base station.

### BRIEF DESCRIPTION OF DRAWINGS

FIG. 1 is a diagram illustrating a wireless communication system according to an embodiment of the present invention.

FIG. 2 is a block diagram illustrating a configuration example of a base station illustrated in FIG. 1.

FIG. 3 is a block diagram illustrating a configuration example of a positioning unit illustrated in FIG. 2.

FIG. 4 is a flowchart illustrating positioning processing executed by a positioning unit with the configuration illustrated in FIG. 3.

FIG. 5 is a block diagram illustrating a configuration example of the positioning unit illustrated in FIG. 2.

FIG. 6 is a flowchart illustrating positioning processing executed by a positioning unit with the configuration illustrated in FIG. 5.

FIG. 7 is a block diagram illustrating a configuration example of the positioning unit illustrated in FIG. 2.

FIG. 8 is a flowchart illustrating positioning processing executed by a positioning unit with the configuration illustrated in FIG. 7.

FIG. 9 is a block diagram illustrating a hardware configuration example of the base station illustrated in FIG. 1.

### DESCRIPTION OF EMBODIMENTS

Embodiments of the present invention will be described below with reference to the drawings.

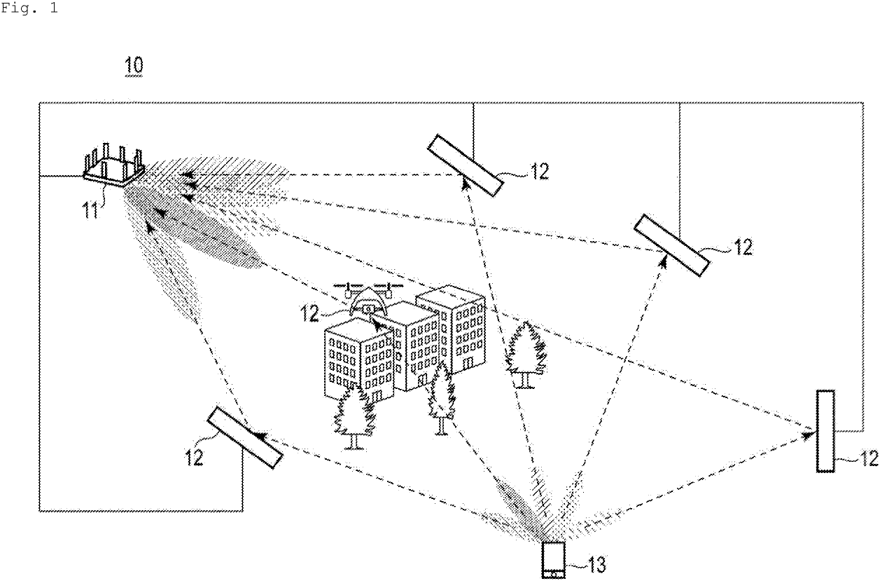

FIG. 1 is a schematic diagram illustrating a wireless communication system 10 including a positioning system according to an embodiment of the present invention. As illustrated in FIG. 1, the wireless communication system 10 is provided with a wireless base station device 11, relay devices 12, and a wireless terminal 13. Herein, the wireless base station device may be simply referred to as the base station, and the wireless terminal may be simply referred to as the terminal.

The base station 11 wirelessly communicates with the terminal 13. The base station 11 may be a mobile communication network base station, for example. The base station 11 has the function of determining the position of the in-communication terminal 13. The terminal 13, for example, may be a mobile terminal, such as a mobile phone, a smart phone, a laptop computer, a game console, or the like.

The relay device 12 relays the wireless signals (radio waves) between the base station 11 and the terminal 13. In a case where the terminal 13 is a transmission station and the base station 11 is a reception station, the relay device 12 receives a wireless signal from the terminal 13 and re-transmits the wireless signal to the base station. In a case where the base station 11 is a transmission station and the terminal 13 is a reception station, the relay device 12 receives a wireless signal from the base station 11 and re-transmits the signal to the terminal 13. The relay device 12 may be a reflector or a repeater, but is not limited thereto. In a case where the relay device 12 includes a reflector, the relay device 12 re-transmits the wireless signal via reflection. As the reflector, for example, a metasurface reflector capable of controlling the angle of reflection of the wireless signals can be used. In a case where the relay device 12 is a repeater, the relay device 12 receives the wireless signals via a first antenna and re-emits the wireless signals via a second antenna. As the repeater, for example, a repeater capable of beamforming can be used. The relay device 12 re-transmits an arrival wave in a discretionary direction by mechanically moving or rotating or electrically controlling the phase of the amplitude.

The relay device 12 is connected to the base station 11 via wired or wireless communication. The relay device 12 may be fixed. The relay device 12 may be capable of moving. For example, the relay device 12 may be installed on a moving body, such as a vehicle, a train, a drone, or the like. In the example illustrated in FIG. 1, four of the relay devices 12 are fixed and connected to the base station 11 via wired communication and one of the relay devices 12 is installed on a drone and connected to the base station 11 via wireless communication. Note that the number of relay devices 12 is not limited to five. It is only required that one or more relay devices 12 are provided.

In a state where the terminal 13 is located in an area without an unobstructed view of the base station 11, the base station 11 and the terminal 13 may communicate with one another via the relay device 12. An area without an unobstructed view is, for example, formed due to obstacles, such as buildings, trees, and the like. In a state where the terminal 13 is located in an area with an unobstructed view of the base station 11, the base station 11 and the terminal 13 may communicate directly with one another or may communicate with one another via the relay device 12.

The base station 11 controls the relay device 12. The base station 11 controls the re-transmission direction of the relay device 12. The re-transmission direction of the relay device 12 is the direction in that the relay device 12 re-transmits. In a case where the relay device 12 is a reflector, the re-transmission direction of the relay device 12 is determined by the angle of reflection and the installation angle (orientation) of the relay device 12. In a case where the relay device 12 is installed on a moving body, the base station 11 may further control the movement of the moving body. The moving body may be capable of autonomous movement with requiring control via the base station 11.

Furthermore, the base station 11 collects relay device information from the relay device 12. The relay device information is information relating to the relay device 12 and may include state information indicating the state of the relay device 12 and sensing information obtained via a sensing function of the relay device 12. The sensing information may include position information indicating the position of the relay device 12 obtained by a GPS sensor or the like and/or installation angle information indicating the installation angle of the relay device 12 obtained by a gyro sensor or the like.

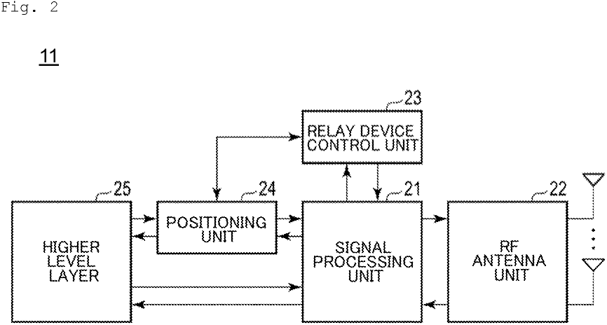

FIG. 2 is a schematic diagram illustrating a configuration example of the base station 11. As illustrated in FIG. 2, the base station 11 is provided with a signal processing unit 21, a radio frequency (RF) antenna unit 22, a relay device control unit 23, a positioning unit 24, and a higher level layer 25.

The signal processing unit 21 generates signals for transmitting. The signal processing unit 21 may receive information from the higher level layer 25 addressed to the terminal 13 and generate a signal containing the received information. The signal processing unit 21 may receive control information from the relay device control unit 23 addressed to the relay device 12 and generate a signal containing the received control information. The RF antenna unit 22 receives a signal from the signal processing unit 21 and executes transmission processing on the received signal. For example, the RF antenna unit 22 obtains an RF signal by using a frequency upconverter to execute upconversion to the system bandwidth of the signal received from the signal processing unit 21. The RF antenna unit 22 amplifies the power of the RF signal via an amplifier (power amplifier) and emits the signal via an antenna.

In reception processing, the RF antenna unit 22 receives an RF signal via an antenna, amplifies the received RF signal via a low noise amplifier, and executes downconversion via a frequency downconverter. The signal processing unit 21 decodes the signal received from the RF antenna unit 22 and passes the obtained information to the relay device control unit 23 or the higher level layer 25. For example, in a case where the signal processing unit 21 obtains relay device information received from the relay device 12, the signal processing unit 21 passes the relay device information to the relay device control unit 23.

The RF antenna unit 22 may include a plurality of antennas and a plurality of RF circuit units associated with the plurality of antennas. In the transmission and reception processing of the RF antenna unit 22, analog beamforming may be executed using a variable phase shifter and a variable gain controller.

The relay device control unit 23 controls the relay device 12. The relay device control unit 23 dynamically controls the re-transmission direction of the relay device 12. The relay device control unit 23 selects, from the multiple relay devices 12, the relay device 12 to use for communication with the terminal 13 and sets the re-emission direction of the selected relay device 12.

The relay device control unit 23 generates control information for controlling the relay device 12 and transmits the information to the relay device 12 via the signal processing unit 21 and the RF antenna unit 22. The control information includes an instruction for controlling the re-transmission direction. The control information may also include an instruction for controlling the moving body installed with the relay device 12. The relay device 12 operates in accordance with the control information from the relay device control unit 23.

The relay device control unit 23 receives the relay device information from the relay device 12 via the signal processing unit 21 and the RF antenna unit 22. The relay device information, as described above, may include the state information of the relay device 12 and sensing information. The relay device control unit 23 stores the information relating to the relay device 12, including position information, re-transmission direction information, and the like. The information stored in the relay device control unit 23 is able to be referenced by the positioning unit 24.

The positioning unit 24 determines the position of the terminal 13. The positioning unit 24 acquires, from the signal processing unit 21, information relating to a wireless signal transmitted by the terminal 13 and received by the base station 11 and estimates the direction of arrival, the time of arrival, and/or the received power of the wireless signal on the basis of the acquired information. The positioning unit 24 estimates the geographical position of the terminal 13 on the basis of the estimation value/s of the direction of arrival, the time of arrival, and/or the received power, the information relating to the relay device 12 obtained via referencing by the relay device control unit 23, and the position information of the base station 11. The positioning unit 24 notifies the higher level layer 25 of the estimated position (estimation result of the position) of the terminal 13.

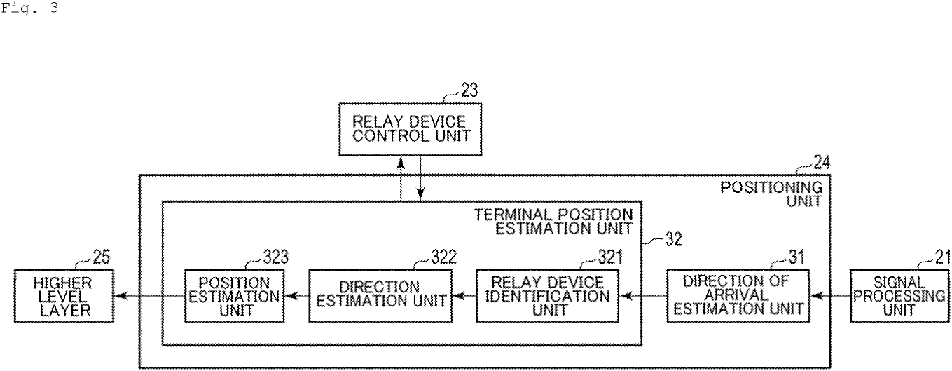

FIG. 3 is a schematic diagram illustrating a first configuration example of the positioning unit 24. In the example illustrated in FIG. 3, the positioning unit 24 is provided with a direction of arrival estimation unit 31 and a terminal position estimation unit 32.

The direction of arrival estimation unit 31 is input with information output from the signal processing unit 21 and estimates the direction of arrival (angle of arrival) of the wireless signal received by the base station 11. The direction of arrival may be estimated using any method. For example, the direction of arrival estimation unit 31 may estimate the direction of arrival on the basis of the direction of the beam used in reception by the base station 11. The direction of arrival estimation unit 31 outputs direction of arrival information indicating the estimated direction of arrival (estimation result of the direction of arrival) to the terminal position estimation unit 32.

The terminal position estimation unit 32 receives the direction of arrival information from the direction of arrival estimation unit 31 and acquires the position information and re-transmission direction information of each relay device 12 from the relay device control unit 23. The terminal position estimation unit 32 holds the position information of the base station 11. The terminal position estimation unit 32 estimates the position of the terminal 13 on the basis of the direction of arrival information, the position information and the re-transmission direction information of the relay device 12, and the position information of the base station 11. The terminal position estimation unit 32 is provided with a relay device identification unit 321, a direction estimation unit 322, and a position estimation unit 323.

The relay device identification unit 321 identifies the relay device 12 that the wireless signal received by the base station 11 passed through on the basis of the estimated direction of arrival of the wireless signal, the position of the base station 11, and the position of the relay device 12. The relay device 12 that the wireless signal received by the base station 11 passed through indicates the relay device 12 in the path (propagation path) between the base station 11 and the terminal 13. In this example, it is assumed that the terminal 13 transmits a plurality of wireless signals to the base station 11 via different relay devices 12. For example, the terminal 13 transmits a first wireless signal to the base station 11 via a first relay device 12, which is one of the relay devices 12, and transmits a second wireless signal to the base station 11 via a second relay device 12, which is another one of the relay devices 12.

The direction estimation unit 322 estimates the direction of the terminal 13 from the relay device 12 on the basis of the re-emission direction of the relay device 12. The direction is estimated for each relay device 12 identified by the relay device identification unit 321.

The position estimation unit 323 estimates the position of the terminal 13 on the basis of the position of the relay device 12 and the estimated direction obtained by the direction estimation unit 322. For example, a position where the direction from the first relay device 12 toward the terminal 13 and the direction from the second relay device 12 toward the terminal 13 intersect is estimated as the position of the terminal 13.

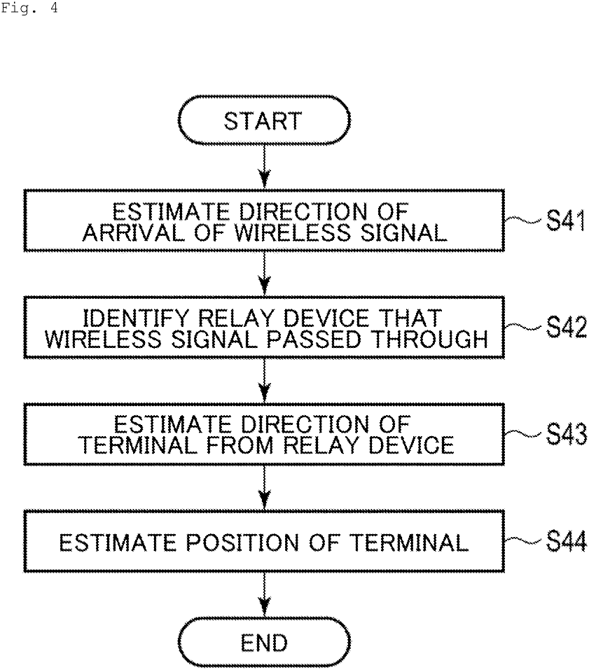

FIG. 4 is a schematic diagram illustrating the positioning processing executed by the positioning unit 24 with the configuration illustrated in FIG. 3. In this example, the terminal 13 transmits a first wireless signal to the base station 11 via a first relay device 12 and transmits a second wireless signal to the base station 11 via a second relay device 12 different from the first relay device 12.

In step S41 of FIG. 4, the direction of arrival estimation unit 31 estimates the direction of arrival of the wireless signal received by the base station 11. For example, the direction of arrival estimation unit 31, from the signal processing unit 21, receives information indicating the direction of the beam used in receiving the first wireless signal and the direction of the beam used in receiving the second wireless signal, estimates the direction of arrival of the first wireless signal from the direction of the beam used in receiving the first wireless signal, and estimates the direction of arrival of the second wireless signal from the direction of the beam used in receiving the second wireless signal.

In step S42, the relay device identification unit 321 identifies the relay device 12 that the wireless signal passed through on the basis of the estimated direction of arrival obtained by the direction of arrival estimation unit 31, the position of the base station 11, and the position of the relay device 12. For example, the relay device identification unit 321 identifies, on the basis of the estimated direction of arrival of the first wireless signal, the position of the base station 11, and the position of the relay device 12, that the relay device 12 that the first wireless signal passed through is the first relay device 12 and identifies, on the basis of the estimated direction of arrival of the second wireless signal, the position of the base station 11, and the position of the relay device 12, that the relay device 12 that the second wireless signal passed through is the second relay device 12.

In step S43, the direction estimation unit 322 estimates the direction of the terminal 13 from the relay device 12 on the basis of the re-transmission direction of the relay device 12 for each relay device 12 identified by the relay device identification unit 321. For example, the direction estimation unit 322 estimates the direction of the terminal 13 from the first relay device 12 on the basis of the re-transmission direction of the first relay device 12 and estimates the direction of the terminal 13 from the second relay device 12 on the basis of the re-transmission direction of the second relay device 12.

In step S44, the position estimation unit 323 estimates the position of the terminal 13 on the basis of the estimated direction obtained by the direction estimation unit 322 and the position of the relay device 12. For example, the position estimation unit 323 estimates, as the position of the terminal 13, a point where a line segment that runs through the position of the first relay device 12 and runs parallel with the estimated direction of the terminal 13 from the first relay device 12 and a line segment that runs through a position of the second relay device 12 and runs parallel with the estimated direction of the terminal 13 from the second relay device 12 intersect.

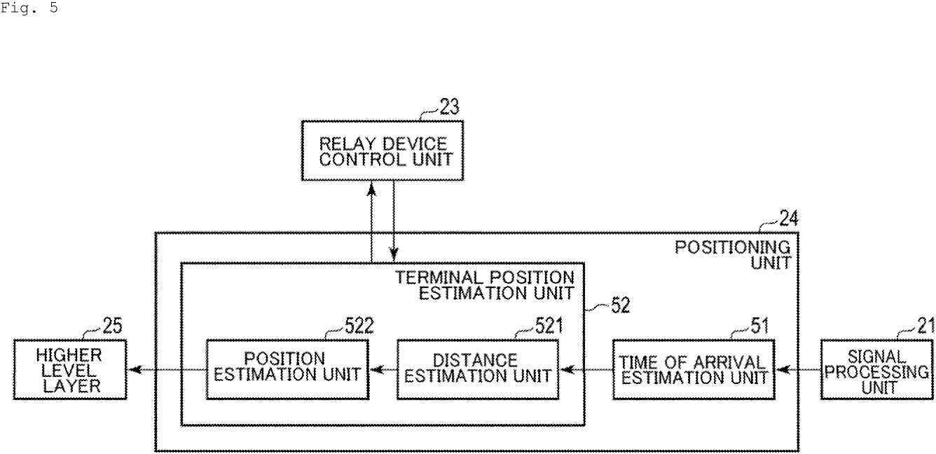

FIG. 5 is a schematic diagram illustrating a second configuration example of the positioning unit 24. In the example illustrated in FIG. 5, the positioning unit 24 is provided with a time of arrival estimation unit 51 and a terminal position estimation unit 52.

The time of arrival estimation unit 51 receives an input of information output from the signal processing unit 21 and estimates the time of arrival of a wireless signal received by the base station 11 on the basis of the received information. The time of arrival may be estimated using any method. For example, the time of arrival may be calculated by the terminal 13 adding time information to a signal and the time of arrival estimation unit 51 comparing the time indicated by the time information contained in the wireless signal received by the base station 11 and the reception time, which is the time the base station 11 received the signal. The time of arrival estimation unit 51 outputs the time of arrival information indicating the estimated time of arrival (estimation result of the time of arrival) of the wireless signal to the terminal position estimation unit 52.

The terminal position estimation unit 52 receives the time of arrival information from the time of arrival estimation unit 51. The terminal position estimation unit 52 acquires the position information of each relay device 12 from the relay device control unit 23. The terminal position estimation unit 52 holds the position information of the base station 11. The terminal position estimation unit 52 estimates the position of the terminal 13 on the basis of the time of arrival information, the position information of the relay device 12, and the position information of the base station 11. The terminal position estimation unit 52 is provided with a distance estimation unit 521 and a position estimation unit 522.

The distance estimation unit 521 estimates the distance between the terminal 13 and the relay device 12 that the wireless signal passed through on the basis of the estimated time of arrival of the wireless signal, the position of the base station 11, and the position of the relay device 12. Specifically, from the position of the base station 11 and the position of the relay device 12 that the wireless signal passed through, the distance estimation unit 521 calculates the time of arrival from the relay device 12 to the base station 11. The distance estimation unit 521 calculates the time of arrival from the terminal 13 to the relay device 12 by subtracting the time of arrival calculated from the relay device 12 to the base station 11 from the estimated time of arrival indicated by the time of arrival information. The distance estimation unit 521 calculates the distance between the terminal 13 and the relay device 12 from the time of arrival calculated from the terminal 13 to the relay device 12. The distance estimation unit 521 may identify the relay device 12 that the wireless signal passed through as described above in relation to FIG. 3. The distance is estimated for each identified relay device 12.

The position estimation unit 522 estimates the position of the terminal 13 on the basis of the estimated distance between the terminal 13 and the relay device 12 obtained by the distance estimation unit 521 and the position of the relay device 12. For example, in a case where the estimated distance between the first relay device 12 and the terminal 13 and the estimated distance between the second relay device 12 and the terminal 13 have been obtained, a point where a first circle with the position of the first relay device 12 as the center and the estimated distance between the first relay device 12 and the terminal 13 as the radius and a second circle with the position of the second relay device 12 as the center and the estimated distance between the second relay device 12 and the terminal 13 as the radius intersect is estimated as the position of the terminal 13. Because there are two points where the two circles intersect, as the position of the terminal 13, the most plausible intersection point is selected from the re-transmittable range of the relay device 12 and the installation angle of the relay device 12.

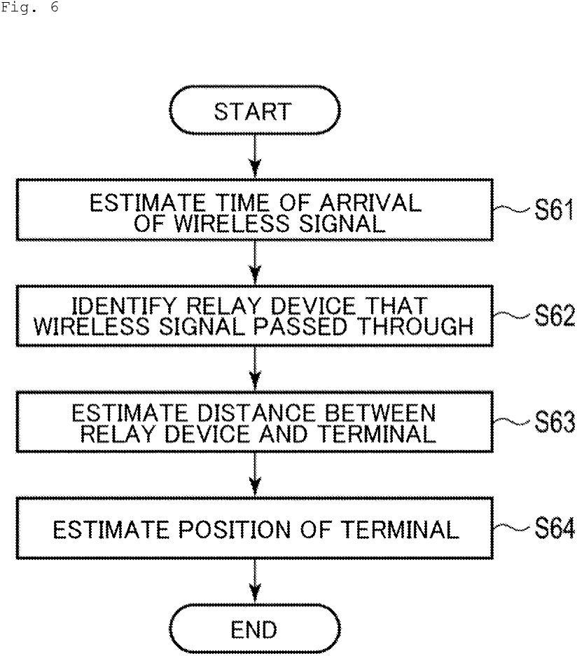

FIG. 6 is a schematic diagram illustrating the positioning processing executed by the positioning unit 24 with the configuration illustrated in FIG. 5. In this example, the terminal 13 transmits a first wireless signal to the base station 11 via a first relay device 12 and transmits a second wireless signal to the base station 11 via a second relay device 12 different from the first relay device 12.

In step S61 of FIG. 6, the time of arrival estimation unit 51 estimates the time of arrival of the wireless signal received by the base station 11. For example, the time of arrival estimation unit 51 receives information indicating the transmission time and the reception time of the first wireless signal from the signal processing unit 21 and obtains the time of arrival of the first wireless signal by subtracting the transmission time from the reception time. Furthermore, the time of arrival estimation unit 51 receives information indicating the transmission time and the reception time of the second wireless signal from the signal processing unit 21 and obtains the time of arrival of the second wireless signal by subtracting the transmission time from the reception time. The transmission time of the wireless signal indicates the time the terminal 13 transmitted the wireless signal and may be set on the basis of the time information contained in the wireless signal.

In step S62, the positioning unit 24 identifies the relay device 12 that the wireless signal passed through. This processing may be executed in a similar manner to the processing described for steps S41 and S42 of FIG. 4. For example, the positioning unit 24 identifies that the first wireless signal passed through the first relay device 12 and identifies that the second wireless signal passed through the second relay device 12.

In step S63, the distance estimation unit 521 estimates the distance between the relay device 12 and the terminal 13 for each relay device 12 identified in step S62 on the basis of the estimated time of arrival, the position of the base station 11, and the position of the relay device 12. For example, the distance estimation unit 521 calculates the distance between the base station 11 and the first relay device 12 from the position of the base station 11 and the position of the first relay device 12 and obtains the time of arrival from the first relay device 12 to the base station 11 by dividing the calculated distance by the speed of light. The distance estimation unit 521 calculates the time of arrival of the first wireless signal from the terminal 13 to the first relay device 12 by subtracting the time of arrival calculated from the first relay device 12 to the base station 11 from the estimated time of arrival of the first wireless signal obtained in step S61. The distance estimation unit 521 calculates the distance between the terminal 13 and the first relay device 12 by multiplying the calculated time of arrival by the speed of light. In a similar manner, the distance estimation unit 521 calculates the distance between the terminal 13 and the second relay device 12.

In step S64, the position estimation unit 522 estimates the position of the terminal 13 on the basis of the estimated distance obtained by the distance estimation unit 521 and the position of the relay device 12. For example, the position estimation unit 522 sets the position of the terminal 13 as a point where a first circle with the position of the first relay device 12 as the center and the estimated distance between the first relay device 12 and the terminal 13 as the radius and a second circle with the position of the second relay device 12 as the center and the estimated distance between the second relay device 12 and the terminal 13 as the radius intersect.

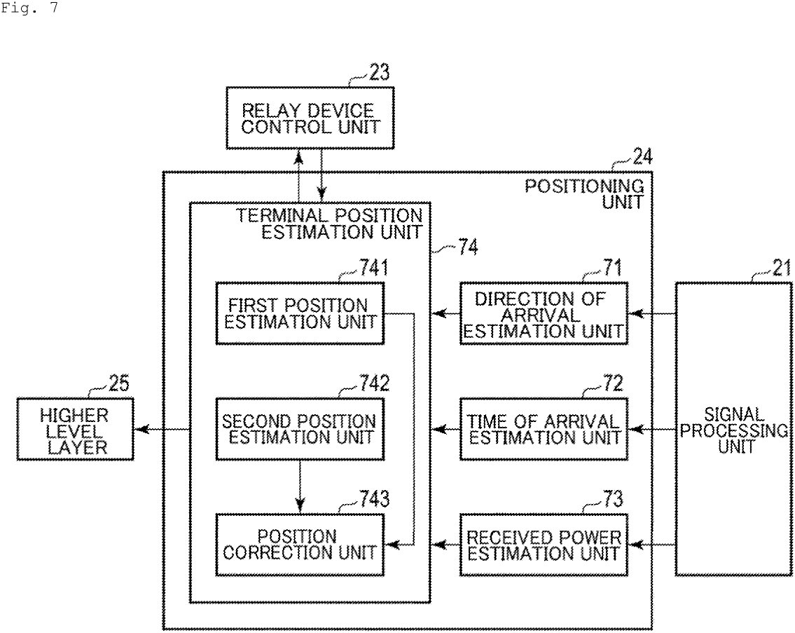

FIG. 7 is a schematic diagram illustrating a third configuration example of the positioning unit 24. In the example illustrated in FIG. 7, the positioning unit 24 is provided with a direction of arrival estimation unit 71, a time of arrival estimation unit 72, a received power estimation unit 73, and a terminal position estimation unit 74.

The direction of arrival estimation unit 71 receives an input of information output from the signal processing unit 21 and estimates the direction of arrival of a wireless signal received by the base station 11 on the basis of the received information. The direction of arrival may be estimated using any method. For example, the direction of arrival estimation unit 71 may estimate the direction of arrival on the basis of the direction of the beam used in reception by the base station 11. The direction of arrival estimation unit 71 outputs direction of arrival information indicating the estimated direction of arrival to the terminal position estimation unit 74.

The time of arrival estimation unit 72 receives an input of information output from the signal processing unit 21 and estimates the time of arrival of a wireless signal received by the base station 11 on the basis of the received information. The time of arrival may be estimated using any method. For example, the time of arrival may be calculated by the terminal 13 adding time information to a signal and the time of arrival estimation unit 72 comparing the time indicated by the time information contained in the signal received by the base station 11 and the reception time. Alternatively, in a case where the base station 11 receives a plurality of wireless signals from the terminal 13 via different relay devices 12, the time of arrival estimation unit 72 may estimate the time of arrival of the next wireless signal on the basis of the difference between the reception time of one wireless signal and the reception time of the next wireless signal. In this case, the timing for when the terminal 13 transmits a wireless signal is scheduled in advance by the base station 11. An example of a method of determining whether or not a plurality of wireless signals passed through different relay devices 12 includes a method in which it is determined that the wireless signals passed through different relay devices 12 in a case where different beams are used by the base station 11 to receive the signals. The time of arrival estimation unit 72 outputs the time of arrival information indicating the estimated time of arrival to the terminal position estimation unit 74.

The received power estimation unit 73 receives an input of information output from the signal processing unit 21 and estimates the received power of a wireless signal received by the base station 11 on the basis of the received information. The received power estimation unit 73 outputs received power information indicating the estimated received power (estimation result of the received power) to the terminal position estimation unit 74.

The terminal position estimation unit 74 is provided with a first position estimation unit 741, a second position estimation unit 742, and a position correction unit 743. The terminal position estimation unit 74 holds the position information of the base station 11.

The first position estimation unit 741 receives the direction of arrival information from the direction of arrival estimation unit 71 and receives the time of arrival information from the time of arrival estimation unit 72. The first position estimation unit 741 acquires position information and re-transmission direction information of each relay device 12 from the relay device control unit 23. The first position estimation unit 741 estimates the position of the terminal 13 on the basis of the direction of arrival information, the time of arrival information, the position information and the re-transmission direction information of the relay device 12, and the position information of the base station 11. The first position estimation unit 741 identifies the base station that the wireless signal passed through on the basis of the estimated direction of arrival of the wireless signal. The first position estimation unit 741 may identify the base station that the wireless signal passed through in a similar manner to the relay device identification unit 321 illustrated in FIG. 3. The first position estimation unit 741 estimates the direction of the terminal 13 from the identified relay device 12 on the basis of the re-emission direction of the identified relay device 12. The first position estimation unit 741 estimates the distance between the identified relay device 12 and the terminal 13 on the basis of the estimated time of arrival of the wireless signal, the position of the identified relay device 12, and the position of the base station 11. The distance can be estimated by a method similar to that described in relation to the distance estimation unit 521 illustrated in FIG. 5. The first position estimation unit 741 estimates the position of the terminal 13 on the basis of the estimated direction of the terminal 13 from the identified relay device 12, the estimated distance between the identified relay device 12 and the terminal 13, and the position of the identified relay device 12. In this case, the position of the terminal 13 can be estimated using a single relay device 12.

Note that the first position estimation unit 741 may estimate the position by a method similar to that of the terminal position estimation unit 32 described in reference to FIG. 3 or may estimate the position by a method similar to that of the terminal position estimation unit 52 described in reference to FIG. 5.

The second position estimation unit 742 receives the direction of arrival information from the direction of arrival estimation unit 71 and receives the received power information from the received power estimation unit 73. The second position estimation unit 742 acquires position information and re-transmission direction information of the relay device 12 from the relay device control unit 23. The second position estimation unit 742 estimates the position of the terminal 13 on the basis of the estimated direction of arrival and the estimated received power of the wireless signal, the position and the re-transmission direction of the relay device 12, and the position of the base station 11.

The second position estimation unit 742 estimates the propagation distance of the wireless signal on the basis of the estimated received power of the wireless signal. The second position estimation unit 742 identifies the relay device 12 that the wireless signal passed through on the basis of the estimated direction of arrival of the wireless signal, the position of the base station 11, and the position of the relay device 12. The second position estimation unit 742 estimates the position of the terminal 13 on the basis of the position of the base station 11, the position and the re-transmission direction of the identified relay device 12, and the estimated propagation distance.

The position correction unit 743 corrects the estimated position obtained by the first position estimation unit 741 using the estimated position obtained by the second position estimation unit 742. For example, the position correction unit 743 sets, as the final estimated position of the terminal 13, a middle point between the estimated position obtained by the first position estimation unit 741 and the estimated position obtained by the second position estimation unit 742.

Note that the position correction unit 743 may set the final estimated position of the terminal 13 by finding a weighted average of the estimated positions. Estimating the position on the basis of the time of arrival has a higher estimation accuracy than estimating the position on the basis of the received power. In other words, the estimated position obtained by the first position estimation unit 741 has a higher likelihood of being correct than the estimated position obtained by the second position estimation unit 742. In this case, the final estimated position may be found by weighting the estimated positions so that the final estimated position is closer to the estimated position obtained by the first position estimation unit 741 than the estimated position obtained by the second position estimation unit 742.

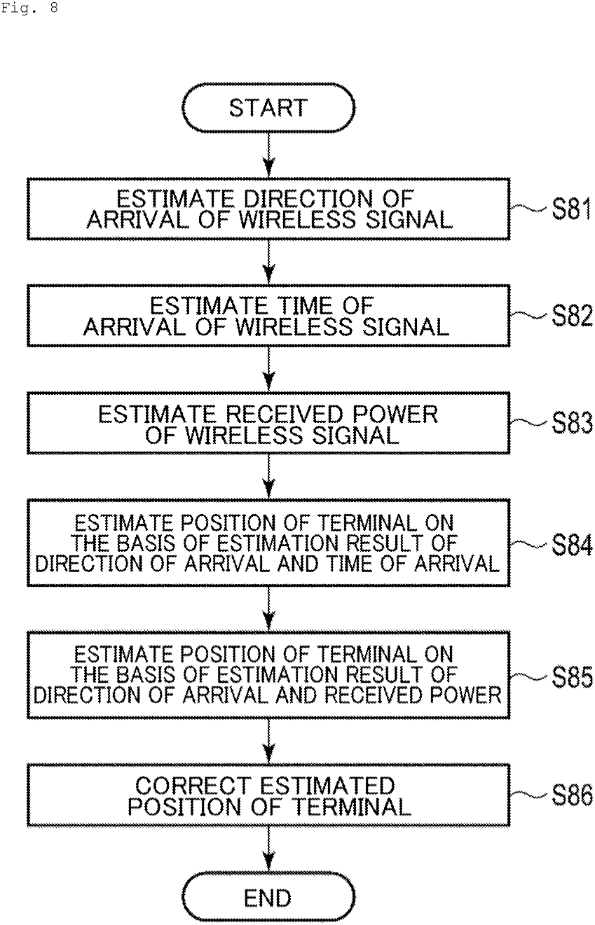

FIG. 8 is a schematic diagram illustrating the positioning processing executed by the positioning unit 24 with the configuration illustrated in FIG. 7. In this example, the terminal 13 transmits a first wireless signal to the base station 11 via a first relay device 12 and transmits a second wireless signal to the base station 11 via a second relay device 12 different from the first relay device 12.

In step S81 of FIG. 8, the direction of arrival estimation unit 71 estimates the direction of arrival of the wireless signal received by the base station 11. For example, the direction of arrival estimation unit 71, from the signal processing unit 21, receives information indicating the direction of the beam used in receiving the first wireless signal and the direction of the beam used in receiving the second wireless signal and estimates the direction of arrival of the first wireless signal and the second wireless signal on the basis of the received information.

In step S82, the time of arrival estimation unit 72 estimates the time of arrival of the wireless signal. For example, the time of arrival estimation unit 72 receives information indicating the transmission time and the reception time of the first wireless signal from the signal processing unit 21 and estimates the time of arrival of the first wireless signal by subtracting the transmission time from the reception time.

In step S83, the received power estimation unit 73 estimates the received power of the wireless signal. For example, the received power estimation unit 73 detects the received power of the second wireless signal.

In step S84, the first position estimation unit 741 estimates the position of the terminal 13 on the basis of the estimated direction of arrival obtained by the direction of arrival estimation unit 71 and the estimated time of arrival obtained by the time of arrival estimation unit 72. For example, the first position estimation unit 741 identifies, from the estimated direction of arrival, the position of the base station 11, and the position of the relay device 12, that the relay device 12 that the first wireless signal passed through is the first relay device 12 and estimates the direction of the terminal 13 from the first relay device 12 from the position and the re-transmission direction of the first relay device 12. Furthermore, the first position estimation unit 741 calculates the distance between the first relay device 12 and the terminal 13 from the estimated time of arrival of the first wireless signal, the position of the base station 11, and the position of the first relay device 12. The first position estimation unit 741 calculates the position of the terminal 13 from the estimated direction of the terminal 13 from the first relay device 12, the estimated distance between the first relay device 12 and the terminal 13, and the position of the first relay device 12.

In step S85, the second position estimation unit 742 estimates the position of the terminal 13 on the basis of the estimated direction of arrival obtained by the direction of arrival estimation unit 71 and the received power value obtained by the received power estimation unit 73. For example, the second position estimation unit 742 identifies that the relay device 12 that the second wireless signal passed through is the second relay device 12 from the estimated direction of arrival, the position of the base station 11, and the position of the relay device 12. The second position estimation unit 742 estimates the direction of the terminal 13 from the second relay device 12 from the position and the re-transmission direction of the second relay device 12. Furthermore, the second position estimation unit 742 estimates the distance between the second relay device 12 and the terminal 13 from the received power value, the position of the base station 11, and the position of the second relay device 12. For example, the second position estimation unit 742 calculates the propagation distance of the wireless signal from the received power value. The second position estimation unit 742 calculates the distance between the base station 11 and the second relay device 12 from the position of the base station 11 and the position of the second relay device 12. The second position estimation unit 742 estimates the distance between the second relay device 12 and the terminal 13 by subtracting the distance calculated between the base station 11 and the second relay device 12 from the calculated propagation distance. Then, the second position estimation unit 742 calculates the position of the terminal 13 from the estimated direction of the terminal 13 from the second relay device 12, the estimated distance between the second relay device 12 and the terminal 13, and the position of the second relay device 12.

In step S86, the position correction unit 743 sets the final position of the terminal 13 on the basis of the estimated positions obtained by the first position estimation unit 741 and the second position estimation unit 742. For example, the position correction unit 743 sets the final position as a middle point between the estimated positions.

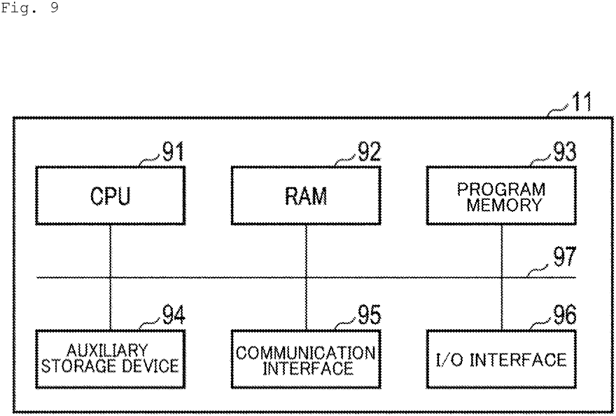

FIG. 9 is a schematic diagram illustrating a hardware configuration example of the base station 11. As illustrated in FIG. 9, the base station 11 is a computer device provided with a central processing unit (CPU) 91, a random access memory (RAM) 92, a program memory 93, an auxiliary storage device 94, a communication interface 95, and an I/O interface 96. The CPU 91 communicates with the RAM 92, the program memory 93, the auxiliary storage device 94, the communication interface 95, and the I/O interface 96 via a bus 97.

The CPU 91 is an example of a general-purpose processor. The RAM 92 is used by the CPU 91 as the working memory. The RAM 92 includes a volatile memory such as synchronous dynamic random access memory (SDRAM) or the like. The program memory 93 non-temporarily stores various programs including a positioning program and a relay device control program and setting data necessary for executing the programs. The programs stored in the program memory 93 include a computer-executable command. When the program is executed by the CPU 91, the program causes the CPU 91 to execute a predetermined processing. As the program memory 93, for example, a read-only memory (ROM), the auxiliary storage device 94, or a combination thereof is used. The auxiliary storage device 94 non-temporarily stores data. The auxiliary storage device 94 includes a non-volatile memory, such as an HDD (hard disk drive), a solid state drive (SSD), or the like.

When the positioning program is executed by the CPU 91, the positioning program causes the CPU 91 to execute the positioning processing described above. For example, the CPU 91 functions as the direction of arrival estimation unit 31 and the terminal position estimation unit 32 in accordance with the positioning program. For example, the CPU 91 functions as the time of arrival estimation unit 51 and the terminal position estimation unit 52 in accordance with the positioning program. The CPU 91 functions as the direction of arrival estimation unit 71, the time of arrival estimation unit 72, the received power estimation unit 73, and the terminal position estimation unit 74 in accordance with the positioning program. When the relay device control program is executed by the CPU 91, the relay device control program causes the CPU 91 to execute the control processing described above. The CPU 91 functions as the relay device control unit 23 in accordance with the relay device control program.

The communication interface 95 is an interface for communicating with other devices. The communication interface 95 includes a wireless module for communicating with the terminal 13. The wireless module may be used to communicate with one or more of the relay devices 12. The wireless module includes the signal processing unit 21 and the RF antenna unit 22. The wireless module may be provided in the form of an IC chip. The communication interface 95 further includes a wired module. The wireless module is used to communicate with other devices, for example, one or more of the relay devices 12, a base station control device that controls the base station 11, and the like.

The I/O interface 96 is provided with a plurality of terminals for connecting an input device and an output device. Examples of the input device include a keyboard, a mouse, a microphone, and the like. Examples of the output device include a display device, a speaker, and the like.

The program may be provide to the base station 11 in a state stored on a computer-readable storage medium. In this case, for example, the base station 11 is further provided with a drive (not illustrated) for reading the data from the storage medium and acquires the program from the storage medium. Examples of the storage medium include a magnetic disk, an optical disk (CD-ROM, CD-R, DVD-ROM, DVD-R, and the like), a magneto-optical disk (MO and the like), and a semiconductor memory. Also, the program may be stored in a server on a communication network, with the base station 11 using the communication interface 95 to download the program from the server.

The processing described in the embodiment is not limited to being executed by a general-purpose processor such as the CPU 91 executing a program and may be execute by a dedicated processor, such as an application specific integrated circuit (ASIC), a field programmable gate array (FPGA), or the like. The processing circuitry includes a general-purpose processor, a dedicated processor, or a combination of a general-purpose processor and a dedicated processor.

As described above, in the wireless communication system 10, the relay device 12 is provided in the wireless channel between the base station 11 and the terminal 13. The positioning unit 24 of the base station 11 estimates the direction of arrival, the time of arrival, and/or the received power of the wireless signal received by the base station 11 from the terminal 13 via the relay device 12 and estimates the position of the terminal 13 on the basis of the estimation value of the direction of arrival, the time of arrival, and/or the received power, the position of the relay device 12, and the position of the base station 11.

By providing the relay device 12, the terminal 13 can be positioned in an area without an unobstructed view of the base station 11 and the position of the terminal 13 can be determined. Furthermore, because the base station 11 performs positioning, the position of the terminal 13 can be determined without being dependent on the performance of the terminal 13. Furthermore, the position of the terminal 13 can be determined with a single base station 11. This means that multiple base stations do not need to be installed for positioning. As a result, an increase in the network equipment costs can be suppressed. Thus, the area in which positioning is able to be performed can be expanded at a low cost.

The positioning unit 24 may estimate the direction of arrival of the wireless signal received by the base station 11 and identify the relay device 12 that the wireless signal passed through on the basis of the estimation result of the direction of arrival. The positioning unit 24, on the basis of the re-transmission direction of the identified relay device 12, may estimate the direction of the terminal 13 as seen from the identified relay device 12 and may estimate the position of the terminal 13 on the basis of the estimation result of the direction of the terminal 13. By using the direction of arrival to identify the relay device 12 that the wireless signal passed through, a robust positioning with respect to the estimation accuracy of the direction of arrival can be achieved. Thus, highly accurate positioning can be performed even when low frequency radio waves are used.

The positioning unit 24 may estimate the time of arrival of the wireless signal received by the base station 11, estimate the distance between the relay device 12 that the wireless signal passed through and the terminal 13 on the basis of the estimation result of the time of arrival, and estimate the position of the terminal 13 on the basis of the estimation result of the distance. By performing positioning on the basis of the time of arrival, a highly accurate positioning can be achieved.

The positioning unit 24 may estimate the direction of the terminal 13 from the relay device 12 on the basis of the re-transmission direction of the relay device 12 that the wireless signal received by the base station 11 passed through, estimate the time of arrival of the wireless signal, estimate the distance between the relay device 12 and the terminal 13 on the basis of the estimation result of the time of arrival, and estimate the position of the terminal 13 on the basis of the estimation result of the direction and the estimation result of the distance. In this manner, positioning of the terminal 13 can be performed using a single relay device 12.

The positioning unit 24 may estimate the received power of the wireless signal and correct the estimated position of the terminal 13 obtained by any one of the methods described above on the basis of the estimation result of the received power. In this manner, the positioning accuracy can be improved.

In the embodiment described above, the positioning unit 24 is located within the base station 11. In other embodiments, the positioning unit 24 may be implemented as a device separate from the base station 11.

Note that the present invention is not limited to the embodiments described above, and other embodiments including various modifications are possible without departing from the scope of the present invention. Also, the embodiments may be combined, if possible, as appropriate to obtain combined effects. Furthermore, the embodiment described above includes various stages of invention, and various inventions may be extracted by combining, as appropriate, the various described configuration conditions.

Reference Signs List

| | |
|---|---|
| 10 | Wireless communication system |
| 11 | Wireless base station device |
| 12 | Relay device |
| 13 | Wireless terminal |
| 21 | Signal processing unit |
| 22 | RF antenna unit |
| 23 | Relay device control unit |
| 24 | Positioning unit |
| 25 | Higher level layer |
| 31 | Direction of arrival estimation unit |
| 32 | Terminal position estimation unit |
| 321 | Relay device identification unit |
| 322 | Direction estimation unit |
| 323 | Position estimation unit |
| 51 | Time of arrival estimation unit |
| 52 | Terminal position estimation unit |
| 521 | Distance estimation unit |
| 522 | Position estimation unit |
| 71 | Direction of arrival estimation unit |
| 72 | Time of arrival estimation unit |
| 73 | Received power estimation unit |
| 74 | Terminal position estimation unit |
| 741 | First position estimation unit |
| 742 | Second position estimation unit |
| 743 | Position correction unit |
| 91 | CPU |
| 92 | RAM |
| 93 | Program memory |
| 94 | Auxiliary storage device |
| 95 | Communication interface |
| 96 | I/O interface |
| 97 | Bus |

1. A positioning system, comprising:
a wireless base station device that communicates with a wireless terminal;
one or more relay devices that relay a signal between the wireless terminal and the wireless base station device; and
a positioning device that estimates a position of the wireless terminal on the basis of a first signal received by the wireless base station device from the wireless terminal via a first relay device, which is one of the one or more relay devices, a position of the one or more relay devices, and a position of the wireless base station device.

2. The positioning system according to claim 1, wherein
the positioning device
estimates a direction of arrival of the first signal, and
identifies the first relay device on the basis of an estimation result of the direction of arrival of the first signal, the position of the one or more relay devices, and the position of the wireless base station device.

3. The positioning system according to claim 1, wherein
the wireless base station device receives a second signal from the wireless terminal via a second relay device, which is another one of the one or more relay devices; and
the positioning device
estimates a direction of the wireless terminal from the first relay device on the basis of a re-transmission direction in which the first relay device re-transmits a signal,
estimates a direction of the wireless terminal from the second relay device on the basis of a re-transmission direction in which the second relay device re-transmits a signal, and
estimates the position of the wireless terminal on the basis of an estimation result of a direction of the wireless terminal from the first relay device, an estimation result of a direction of the wireless terminal from the second relay device, a position of the first relay device, and a position of the second relay device.

4. The positioning system according to claim 1, wherein
the wireless base station device receives a second signal from the wireless terminal via a second relay device, which is another one of the one or more relay devices; and
the positioning device
estimates a time of arrival of the first signal from the wireless terminal to the wireless base station device,
estimates a distance between the first relay device and the wireless terminal on the basis of an estimation result of the time of arrival of the first signal from the wireless terminal to the wireless base station device, the position of the wireless base station device, and a position of the first relay device,
estimates a time of arrival of the second signal from the wireless terminal to the wireless base station device,
estimates a distance between the second relay device and the wireless terminal on the basis of an estimation result of the time of arrival of the second signal from the wireless terminal to the wireless base station device, the position of the wireless base station device, and a position of the second relay device, and
estimates the position of the wireless terminal on the basis of the position of the first relay device, an estimation result of a distance between the first relay device and the wireless terminal, the position of the second relay device, and an estimation result of a distance between the second relay device and the wireless terminal.

5. The positioning system according to claim 1, wherein
the positioning device
estimates a direction of the wireless terminal from the first relay device on the basis of a re-transmission direction in which the first relay device re-transmits a signal,
estimates a time of arrival of the first signal from the wireless terminal to the wireless base station device,
estimates a distance between the first relay device and the wireless terminal on the basis of an estimation result of the time of arrival of the first signal from the wireless terminal to the wireless base station device, the position of the wireless base station device, and a position of the first relay device, and
estimates the position of the wireless terminal on the basis of an estimation result of a direction of the wireless terminal from the first relay device, an estimation result of a distance between the first relay device and the wireless terminal, and the position of the first relay device.

6. The positioning system according to claim 1, wherein
the wireless base station device receives a second signal from the wireless terminal via a second relay device, which is another one of the one or more relay devices; and
the positioning device
estimates a received power of the second signal, and
corrects an estimation result of the position of the wireless terminal on the basis of an estimation result of the received power.

7. A positioning method executed by a positioning device, comprising:
estimating a position of a wireless terminal on the basis of a signal received by a wireless base station device from the wireless terminal via a first relay device, which is one of one or more relay devices, a position of the one or more relay devices, and a position of the wireless base station device.

8. A wireless base station device, comprising:
a communication unit that communicates with a wireless terminal and receives a signal from the wireless terminal via a first relay device, which is one of one or more relay devices; and
a positioning unit that estimates a position of the wireless terminal on the basis of the signal, a position of the one or more relay devices, and a position of the wireless base station device.
